(19) United States
(12) Patent Application Publication
(10) Pub. No.: US 2023/0216768 A1
(43) Pub. Date: Jul. 6, 2023

(54) ENHANCED PATH SELECTION USING ONLINE DETECTION OF PATHS OVERLAPS

(71) Applicant: VMware, Inc., Palo Alto, CA (US)

(72) Inventors: Eyal Zohar, Shimshit (IL); Alex Markuze, Rosh HaAyin (IL); Chen Dar, Magshimim (IL); Aran Bergman, Givatayim (IL); Igor Golikov, Kfar Saba (IL); Israel Cidon, San Francisco, CA (US)

(21) Appl. No.: 18/088,556

(22) Filed: Dec. 24, 2022

Related U.S. Application Data
(60) Provisional application No. 63/296,473, filed on Jan. 4, 2022.

(51) Int. Cl. H04L 43/0864; H04L 43/0829

(52) U.S. Cl. CPC H04L 43/0864; H04L 43/0841

(57) ABSTRACT

The method of some embodiments selects a backup overlay network route when rerouting data packets to avoid delays on a primary overlay network route. The method, for each of multiple overlay network routes, measures delays of data packet transmissions on the overlay network route. The method correlates changes in the delays of data packet transmissions sent through different overlay network routes of the plurality of overlay network routes. The method selects the backup overlay network route based on the backup overlay network route having a low correlation or no correlation of changes of delays with the primary overlay route. In some embodiments, multiple physical network routes underlie the multiple overlay network routes, and correlating changes in the delays of data packet transmissions sent through different overlay network routes of the plurality of overlay network routes includes identifying overlay network routes for which the underlying physical network routes share infrastructure.

Modern virtual networks (e.g., SD-WANs) may include multiple branches at widespread physical locations. When sending data from one branch to another the data are sent along routes in the virtual network that are in turn implemented by physical routing elements of an underlying physical network. The routing elements of the virtual network are not provided with data identifying the entire route of the underlying physical data over which the data is sent on a given route of the virtual network. When there is network congestion or network breakdowns along a physical route underlying a particular virtual route, the routers of the virtual network may send data along a backup route. However, because the routing elements of the virtual network do not have data identifying the physical route, those routing elements may choose a backup route that uses the same congested or broken down physical routing elements.

Choosing a virtual network backup route with the same underlying physical routing elements may thus result in the data being delayed along the backup route as well, defeating the purpose of having a separate backup route in the virtual network. Therefore, there is a need in the art for a way for the virtual network routing elements to identify routes through the virtual network which share common physical routing elements and routes which share few if any common physical routing elements in order to choose backup routes that are unlikely to have delays when the primary routes have delays.

### BRIEF SUMMARY

The method of some embodiments selects a backup overlay network route when rerouting data packets to avoid delays on a primary overlay network route. The method, for each of multiple overlay network routes, measures delays of data packet transmissions on the overlay network route. The method correlates changes in the delays of data packet transmissions sent through different overlay network routes of the multiple overlay network routes. The method selects the backup overlay network route based on the backup overlay network route having a low correlation or no correlation of changes of delays with the primary overlay route. In some embodiments, multiple physical network routes underlie the multiple overlay network routes, and correlating changes in the delays of data packet transmissions sent through different overlay network routes of the multiple overlay network routes includes identifying overlay network routes for which the underlying physical network routes share infrastructure. The shared infrastructure may include links in the physical network route.

Correlating changes in the delays of data packet transmissions sent through different overlay network routes of the multiple overlay network routes, in some embodiments, includes identifying an increase in the round trip time along each of at least two routes within a threshold amount of time. The increase in the round trip time along each of the routes is more than a threshold increase, in some embodiments. Correlating changes in the delays of data packet transmissions sent through different overlay network routes of the multiple overlay network routes, in some embodiments, includes identifying a decrease in the round trip time along each of at least two routes within a threshold amount of time. The decrease in the round trip time along each of the routes is more than a threshold decrease in some embodiments.

Measuring the delays, in some embodiments, includes receiving, from an agent on at least one of a gateway of the overlay network and an endpoint of the overlay network, round trip time data for each overlay route. Measuring the delays includes receiving, from an agent on at least one of a gateway of the overlay network and an endpoint of the overlay network, latency time data for each overlay route, in some embodiments. Measuring the delays includes receiving, from an agent on at least one of a gateway of the overlay network and an endpoint of the overlay network, packet error data for each underlying route, in some embodiments. Measuring the delays includes receiving, from an agent on at least one of gateways of the overlay network and endpoints of the overlay network, network interruption data for each underlying route, in some embodiments. In some embodiments, low correlation means a low correlation relative to correlations of other possible backup overlay network routes.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF THE DRAWINGS

The novel features of the invention are set forth in the appended claims. However, for purposes of explanation, several embodiments of the invention are set forth in the following figures.

FIG. 1 presents a virtual network that is defined for a corporation over several public cloud datacenters and of two public cloud providers A and B.

FIG. 2 conceptually illustrates a process of some embodiments for selecting a backup route in an overlay network.

FIG. 3 illustrates a branch node of some embodiments.

FIG. 4 illustrates an example of route delay data for four routes with correlations.

FIG. 5 illustrates an example of four routes that could produce the data shown in FIG. 4.

FIG. 6 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

The method of some embodiments selects a backup overlay network route when rerouting data packets to avoid delays on a primary overlay network route. The method, for each of multiple overlay network routes, measures delays of data packet transmissions on the overlay network route. The method correlates changes in the delays of data packet transmissions sent through different overlay network routes of the multiple overlay network routes. The method selects the backup overlay network route based on the backup overlay network route having a low correlation or no correlation of changes of delays with the primary overlay route. In some embodiments, multiple physical network routes underlie the multiple overlay network routes, and correlating changes in the delays of data packet transmissions sent through different overlay network routes of the multiple overlay network routes includes identifying overlay network routes for which the underlying physical network routes share infrastructure. The shared infrastructure may include links in the physical network route.

Correlating changes in the delays of data packet transmissions sent through different overlay network routes of the multiple overlay network routes, in some embodiments, includes identifying an increase in the round trip time along each of at least two routes within a threshold amount of time. The increase in the round trip time along each of the routes is more than a threshold increase, in some embodiments. Correlating changes in the delays of data packet transmissions sent through different overlay network routes of the multiple overlay network routes, in some embodiments, includes identifying a decrease in the round trip time along each of at least two routes within a threshold amount of time. The decrease in the round trip time along each of the routes is more than a threshold decrease in some embodiments.

Measuring the delays, in some embodiments, includes receiving, from an agent on at least one of a gateway of the overlay network and an endpoint of the overlay network, round trip time data for each overlay route. Measuring the delays includes receiving, from an agent on at least one of a gateway of the overlay network and an endpoint of the overlay network, latency time data for each overlay route, in some embodiments. Measuring the delays includes receiving, from an agent on at least one of a gateway of the overlay network and an endpoint of the overlay network, packet error data for each underlying route, in some embodiments. Measuring the delays includes receiving, from an agent on at least one of gateways of the overlay network and endpoints of the overlay network, network interruption data for each underlying route, in some embodiments. In some embodiments, low correlation means a low correlation relative to correlations of other possible backup overlay network routes.

As used in this document, data messages refer to a collection of bits in a particular format sent across a network. One of ordinary skill in the art will recognize that the term data message may be used herein to refer to various formatted collections of bits that may be sent across a network, such as Ethernet frames, IP packets, TCP/IP packets, TCP segments, UDP datagrams, etc. Also, as used in this document, references to L2, L3, L4, and L7 layers (or layer 2, layer 3, layer 4, layer 7) are references, respectively, to the second data link layer, the third network layer, the fourth transport layer, and the seventh application layer of the OSI (Open System Interconnection) layer model. TCP/IP packets include an addressing tuple (e.g., a 5-tuple specifying a source IP address, source port number, destination IP address, destination port address and protocol). Network traffic refers to a set of data packets sent through a network. For example, network traffic could be sent from an application operating on a machine (e.g., a virtual machine or physical computer) on a branch of an SD-WAN through a hub node of a hub cluster of the SD-WAN. As used herein, the term “data stream” refers to a set of data sent from a particular source (e.g., a machine on a network node) to a particular destination (e.g., a machine on a different network node) and return packets from that destination to the source. One of ordinary skill in the art will understand that the inventions described herein may be applied to packets of a particular data stream going in one direction or to packets going in both directions.

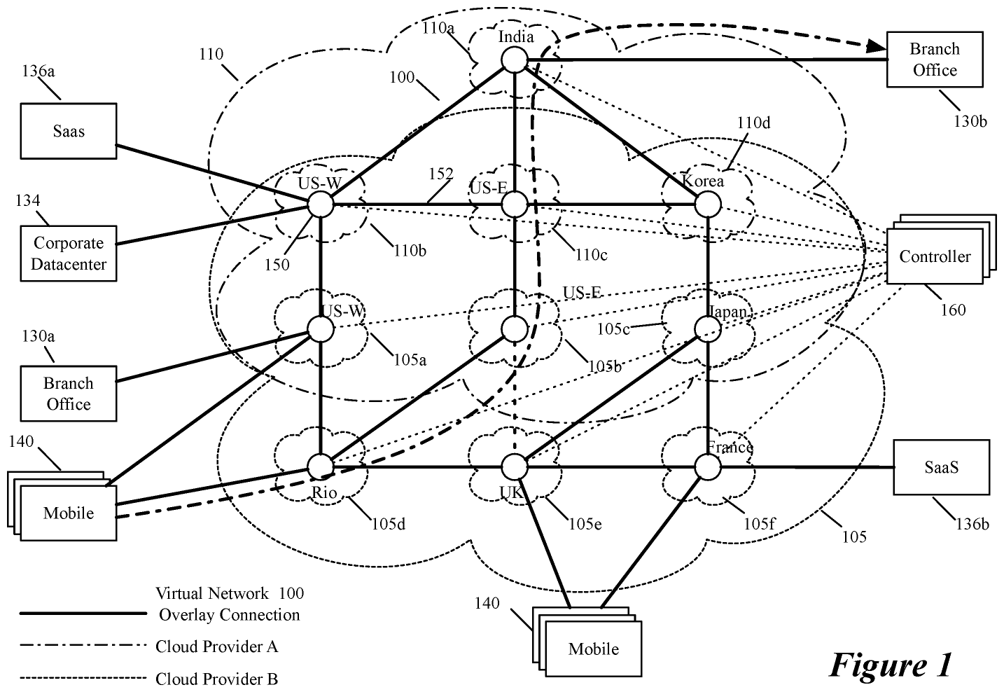

FIG. 1 presents a virtual network 100 that is defined for a corporation over several public cloud datacenters 105 and 110 of two public cloud providers A and B. As shown, the virtual network 100 is a secure overlay network that is established by deploying different managed forwarding nodes 150 in different public clouds and connecting the managed forwarding nodes (MFNs) to each other through overlay tunnels 152. In some embodiments, an MFN is a conceptual grouping of several different components in a public cloud datacenter that with other MFNs (with other groups of components) in other public cloud datacenters establish one or more overlay virtual networks for one or more entities.

One of ordinary skill in the art will understand that the overlay tunnels are not physical entities, but instead are conceptual tunnels that are used to represent the actions of a CFE of the VPN encrypting (sometimes called “encapsulating”) data packets at one end of the virtual tunnel so that only another CFE, conceptually represented as the other end of the tunnel, can de-encapsulate/decrypt the packets to restore the original data packets. While the packets may be transferred along many different physical routes through the underlying network(s), the contents are protected, from third party inspection, by the encapsulation.

As further described below, the group of components that form an MFN include in some embodiments (1) one or more gateways for establishing VPN connections with an entity's compute nodes (e.g., offices, private datacenters, remote users, etc.) that are external machine locations outside of the public cloud datacenters, (2) one or more cloud forwarding elements (CFEs) for encapsulating data messages and forwarding encapsulated data messages between each other in order to define an overlay virtual network over the shared public cloud network fabric, (3) one or more service machines for performing middlebox service operations as well as L4-L7 optimizations, and (4) one or more measurement agents for obtaining measurements regarding the network connection quality between the public cloud datacenters in order to identify desired paths through the public cloud datacenters. In some embodiments, different MFNs can have different arrangements and different numbers of such components, and one MFN can have different numbers of such components for redundancy and scalability reasons.

Also, in some embodiments, each MFN's group of components execute on different computers in the MFN's public cloud datacenter. In some embodiments, several or all of an MFN's components can execute on one computer of a public cloud datacenter. The components of an MFN in some embodiments execute on host computers that also execute other machines of other tenants. These other machines can be other machines of other MFNs of other tenants, or they can be unrelated machines of other tenants (e.g., compute VMs or containers).

The virtual network 100 in some embodiments is deployed by a virtual network provider (VNP) that deploys different virtual networks over the same or different public cloud datacenters for different entities (e.g., different corporate customers/tenants of the virtual network provider). The virtual network provider in some embodiments is the entity that deploys the MFNs and provides the controller cluster for configuring and managing these MFNs.

The virtual network 100 connects the corporate compute endpoints (such as datacenters, branch offices and mobile users) to each other and to external services (e.g., public web services, or SaaS services such as Office365 or Salesforce) that reside in the public cloud or reside in private datacenter accessible through the Internet. This virtual network leverages the different locations of the different public clouds to connect different corporate compute endpoints (e.g., different private networks and/or different mobile users of the corporation) to the public clouds in their vicinity. Corporate compute endpoints are also referred to as corporate compute nodes in the discussion below.

In some embodiments, the virtual network 100 also leverages the high-speed networks that interconnect these public clouds to forward data messages through the public clouds to their destinations or to get close to their destinations while reducing their traversal through the Internet. When the corporate compute endpoints are outside of public cloud datacenters over which the virtual network spans, these endpoints are referred to as external machine locations. This is the case for corporate branch offices, private datacenters and devices of remote users.

In the example illustrated in FIG. 1, the virtual network 100 spans six datacenters 105a-105f of the public cloud provider A and four datacenters 110a-110d of the public cloud provider B. In spanning these public clouds, this virtual network connects several branch offices, corporate datacenters, SaaS providers and mobile users of the corporate tenant that are located in different geographic regions. Specifically, the virtual network 100 connects two branch offices 130a and 130b in two different cities (e.g., San Francisco, Calif., and Pune, India), a corporate datacenter 134 in another city (e.g., Seattle, Wash.), two SaaS provider datacenters 136a and 136b in another two cities (Redmond, Wash., and Paris, France), and mobile users 140 at various locations in the world. As such, this virtual network can be viewed as a virtual corporate WAN.

In some embodiments, the branch offices 130a and 130b have their own private networks (e.g., local area networks) that connect computers at the branch locations and branch private datacenters that are outside of public clouds. Similarly, the corporate datacenter 134 in some embodiments has its own private network and resides outside of any public cloud datacenter. In other embodiments, however, the corporate datacenter 134 or the datacenter of the branch 130a and 130b can be within a public cloud, but the virtual network does not span this public cloud, as the corporate 134 or branch datacenter 130a connects to the edge of the virtual network 100. In some embodiments, a corporate 134 or branch datacenter 130a may connect to the edge of the virtual network 100 through an IP security (IPsec) tunnel.

As mentioned above, the virtual network 100 is established by connecting different deployed managed forwarding nodes 150 in different public clouds through overlay tunnels 152. Each managed forwarding node 150 includes several configurable components. As further described above and further described below, the MFN components include in some embodiments software-based measurement agents, software forwarding elements (e.g., software routers, switches, gateways, etc.), layer 4 proxies (e.g., TCP proxies) and middlebox service machines (e.g., VMs, containers, etc.). One or more of these components in some embodiments use standardized or commonly available solutions, such as Open vSwitch, OpenVPN, strongSwan, etc.

In some embodiments, each MFN (i.e., the group of components the conceptually forms an MFN) can be shared by different tenants of the virtual network provider that deploys and configures the MFNs in the public cloud datacenters. Conjunctively, or alternatively, the virtual network provider in some embodiments can deploy a unique set of MFNs in one or more public cloud datacenters for a particular tenant. For instance, a particular tenant might not wish to share MFN resources with another tenant for security reasons or quality of service reasons. For such a tenant, the virtual network provider can deploy its own set of MFNs across several public cloud datacenters.

In some embodiments, a logically centralized controller cluster 160 (e.g., a set of one or more controller servers) operate inside or outside of one or more of the public clouds 105 and 110, and configure the public-cloud components of the managed forwarding nodes 150 to implement the virtual network 100 over the public clouds 105 and 110. In some embodiments, the controllers in this cluster are at various different locations (e.g., are in different public cloud datacenters) in order to improve redundancy and high availability. The controller cluster in some embodiments scales up or down the number of public cloud components that are used to establish the virtual network 100, or the compute or network resources allocated to these components.

In some embodiments, the controller cluster 160, or another controller cluster of the virtual network provider, establishes a different virtual network for another corporate tenant over the same public clouds 105 and 110, and/or over different public clouds of different public cloud providers. In addition to the controller cluster(s), the virtual network provider in other embodiments deploys forwarding elements and service machines in the public clouds that allow different tenants to deploy different virtual networks over the same or different public clouds. The potential for additional tenants to operate on the same public clouds increases the security risk of unencrypted packets, providing a further incentive for a client to use VPN tunnels to protect data from third parties.

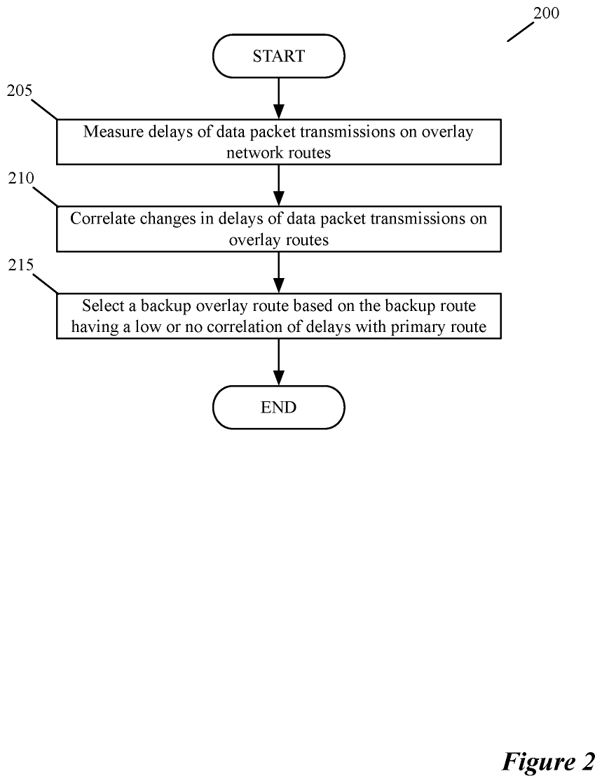

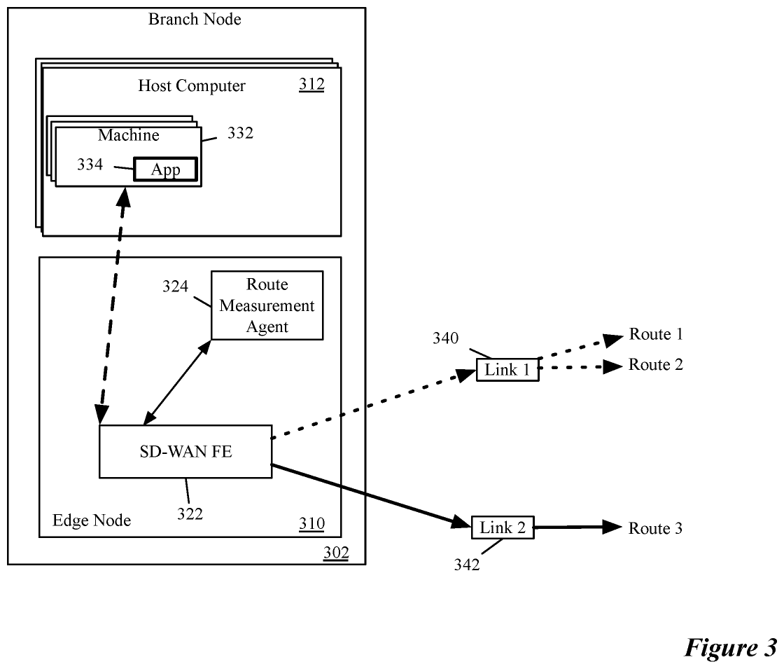

FIG. 2 conceptually illustrates a process 200 of some embodiments for selecting a backup route in an overlay network. The process 200 measures (at 205) delays of data packet transmissions on multiple overlay network routes. These measurements, in some embodiments, are performed by agents on edge and/or hub nodes of a virtual network (e.g., an SD-WAN). The agents of some embodiments are further described with respect to FIG. 3, below.

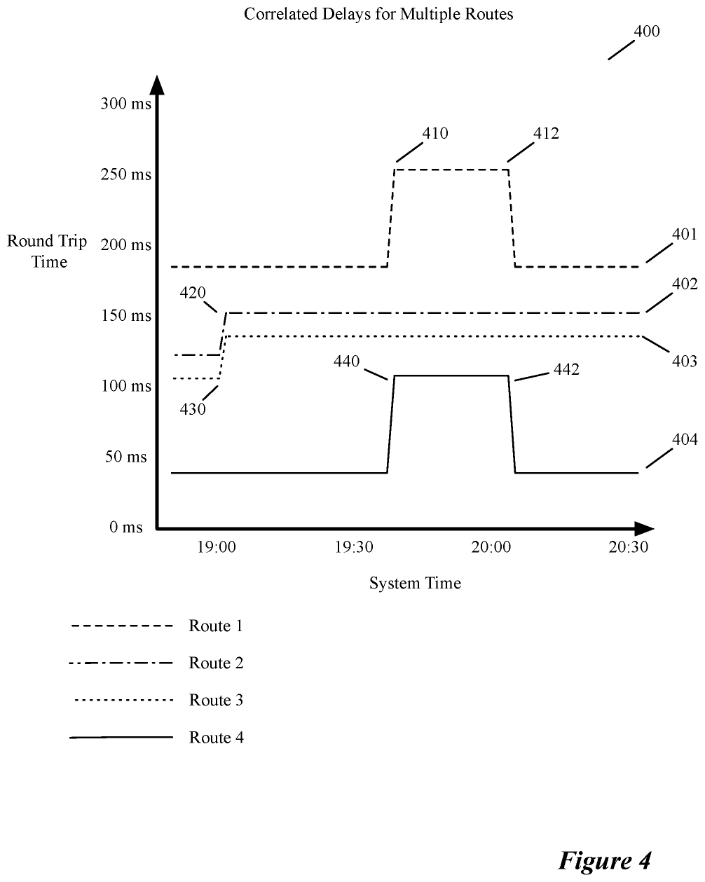

The process 200 then correlates (at 210) changes in delays of packet transmissions on overlay routes. These correlations are made by identifying when two different overlay routes experience similar changes in the amount of time it takes to route a packet and/or a reply through each of the overlay routes. In overlay routes that do not share any underlying physical routing elements (e.g., routers, links, etc.) there should be little or no correlation in changes of delays over short periods of time. Accordingly, when two routes through the overlay network both experience a sudden increase or decrease in round trip time for sending packets, it is most likely because the two routes are both sending data packets through the same physical network routing element that is causing the increase or decrease in delay of in both routes. An increase in round trip time may be caused by sudden congestion or routing around a downed routing element. Similarly, a decrease in round trip time may be caused by a sudden end to congestion or a downed element returning to normal operation. Examples of routes with correlated changes in round trip time are provided in FIG. 4, below. The process 200 then selects (at 215) a backup overlay route based on the selected backup route having low or no correlation of delays with a primary overlay route. The process 200 then ends.

FIG. 3 illustrates branch node 302 of some embodiments. The branch node 302 includes an edge node 310 and host computers 312. The edge node 310 includes an SD-WAN forwarding element (FE) 322 and a route measurement agent 324. In some embodiments, the edge node 310 is implemented on a server or a host computer 312 of the branch node 302. The host computer 312 includes host machines 332 and an application 334 implemented by a host machine 332. The application 334 sends data packets to the SD-WAN FE 322 which then sends the packets to other branches of the SD-WAN network through routes that pass through two links 340 and 342. In some embodiments, the SD-WAN forwarding elements (like FE 322) are software routers executing on host computers, or hardware routers, or a combination of software and hardware routers.

In some embodiments, the links are wired or wireless connections of a physical network. Although the branch node 302 only uses two links to other branches, one of ordinary skill in the art will understand that branch nodes of some embodiments can use any number of links. As shown by the two routes branching from link 340, multiple routes to other branches may be accessed through each link in some embodiments. One of ordinary skill in the art will understand that the routes branching from the link are conceptual representations of routes branching from (not shown) routing elements to which the link 340 directly or indirectly connects.

The route measurement agent 324 monitors one or more aspects of routes to other branch nodes (not shown) and/or other network locations. In some embodiments, the route measurement agent 324 measures round trip time data for each overlay route (e.g., by tracking the times at which one or more packets sent on each route are sent and a corresponding echo or reply packet is received). In some embodiments, the route measurement agent 324 measures latency time data for each overlay route (e.g., in conjunction with route monitoring agents operating on other branch nodes to identify the arrival time of packets at the other branch nodes). In some embodiments, the route measurement agent 324 measures other network statistics such as packet error data or data relating to network interruption data for each underlying route. One of ordinary skill in the art will understand that in some embodiments, a route measurement agent may be a separate piece of software running on a computer 312 or other hardware device of the branch node 302, a software element integrated with the SD-WAN FE 322.

In some embodiments, route measurement data is correlated from multiple route measurement agents 324 on multiple edge nodes 310 at multiple branch nodes 302. Some such embodiments receive data from the multiple measurement agents 324 at a central location (e.g., a network controller of the SD-WAN). Other such embodiments receive data from the multiple measurement agents 324 at multiple locations (e.g., at each edge node 310 of the SD-WAN). Although FIG. 3 illustrates a route monitoring agent 324 being a separate entity (e.g., a separate software component) from the SD-WAN FE 322, one of ordinary skill in the art will understand that in other embodiments, the functions of the route monitoring agent 324 may be performed by the SD-WAN FE 322 itself. One of ordinary skill in the art will understand that in some embodiments, route monitoring agents may operate on hub nodes of datacenters or on gateways in addition to or instead of operating on edge nodes.

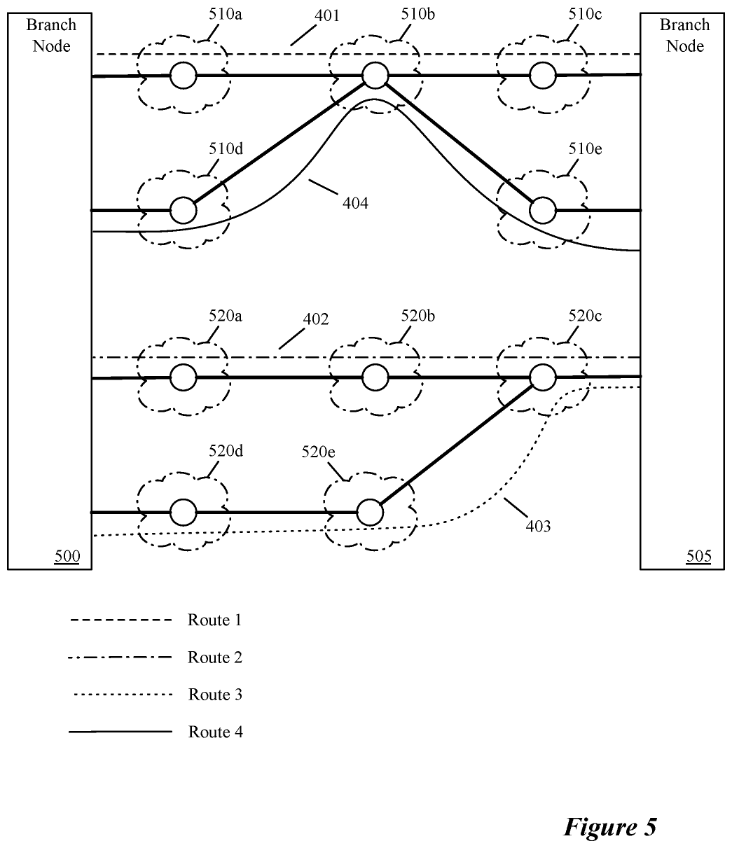

Once data on various routes is collected, the method of some embodiments correlated the data to determine which routes have correlations in their route delays. FIG. 4 illustrates an example of route delay data for four routes with correlations. An example of such routes is described below with respect to FIG. 5. The data is displayed in FIG. 4 as a graph 400 with round trip times for four routes 401-404. Route 401 is correlated with route 404 as shown by the near simultaneous increases 410 and 440 and the near simultaneous decreases 412 and 442 in round trip time. Similarly, route 402 is correlated with route 403 as shown by the near simultaneous increases 420 and 430 in round trip time. One of ordinary skill in the art will understand that these correlations are evidence that routes 401 and 404 share underlying physical routing elements with each other and that routes 402 and 403 share underlying physical routing elements with each other. However, Route 401 and 402 (and other pairwise combinations of routes) do not share underlying physical routing elements as the changes in network delays are not correlated for those pairs. Accordingly, the method of some embodiments could assign route 402 or route 403 as backup routes for route 401, etc.

FIG. 5 illustrates an example of four routes that could produce the data shown in FIG. 4. FIG. 5 includes branch nodes 500 and 505 with four possible routes 401-404 between the branch nodes 500 and 505. The routes 401-404 each pass through three of the public cloud datacenters 510a-510e and 520a-520e. Route 401 passes through public cloud datacenters 510a, 510b, and 510c. Route 404 passes through public cloud datacenters 510d, 510b, and 510e. Because both routes 401 and 404 pass through public cloud datacenter 510b, both routes 401 and 404 are vulnerable to a disruption of public cloud datacenter 510b. A disruption (e.g., a sudden traffic increase) of public cloud datacenter 510b starting at approximately time 19:35 could cause increases 410 and 440, of the round trip times of routes 401 and 404, respectively, in FIG. 4. Similarly, an end to such a disruption at approximately time 20:05 could cause decreases 412 and 442 of the round trip times of routes 401 and 404, respectively.

Similarly, route 402 passes through public cloud datacenters 520a, 520b, and 520c, in FIG. 5. Route 403 passes through public cloud datacenters 520d, 520e, and 520c. Because both routes 402 and 403 pass through public cloud datacenter 520c, both routes 402 and 403 are vulnerable to a disruption of public cloud datacenter 520c. A disruption (e.g., a sudden traffic increase) of public cloud datacenter 520c starting at approximately time 19:00 could cause increases 420 and 430, of the round trip times of routes 402 and 403, respectively, in FIG. 4. One of ordinary skill in the art will understand that the methods of the present invention determine which routes pass through common locations without having to identify which particular locations are the common ones. Accordingly, the methods of the present invention would allow a rejection of route 401 as a backup route for route 404 without the route selecting element being specifically notified that both routes 401 and 404 pass through public cloud datacenter 510b.

This specification refers throughout to computational and network environments that include virtual machines (VMs). However, virtual machines are merely one example of data compute nodes (DCNs) or data compute end nodes, also referred to as addressable nodes. DCNs may include non-virtualized physical hosts, virtual machines, containers that run on top of a host operating system without the need for a hypervisor or separate operating system, and hypervisor kernel network interface modules.

VMs, in some embodiments, operate with their own guest operating systems on a host using resources of the host virtualized by virtualization software (e.g., a hypervisor, virtual machine monitor, etc.). The tenant (i.e., the owner of the VM) can choose which applications to operate on top of the guest operating system. Some containers, on the other hand, are constructs that run on top of a host operating system without the need for a hypervisor or separate guest operating system. In some embodiments, the host operating system uses name spaces to isolate the containers from each other and therefore provides operating-system level segregation of the different groups of applications that operate within different containers. This segregation is akin to the VM segregation that is offered in hypervisor-virtualized environments that virtualize system hardware, and thus can be viewed as a form of virtualization that isolates different groups of applications that operate in different containers. Such containers are more lightweight than VMs.

Hypervisor kernel network interface modules, in some embodiments, are non-VM DCNs that include a network stack with a hypervisor kernel network interface and receive/transmit threads. One example of a hypervisor kernel network interface module is the vmknic module that is part of the ESXi™ hypervisor of VMware, Inc.

It should be understood that while the specification refers to VMs, the examples given could be any type of DCNs, including physical hosts, VMs, non-VM containers, and hypervisor kernel network interface modules. In fact, the example networks could include combinations of different types of DCNs in some embodiments.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

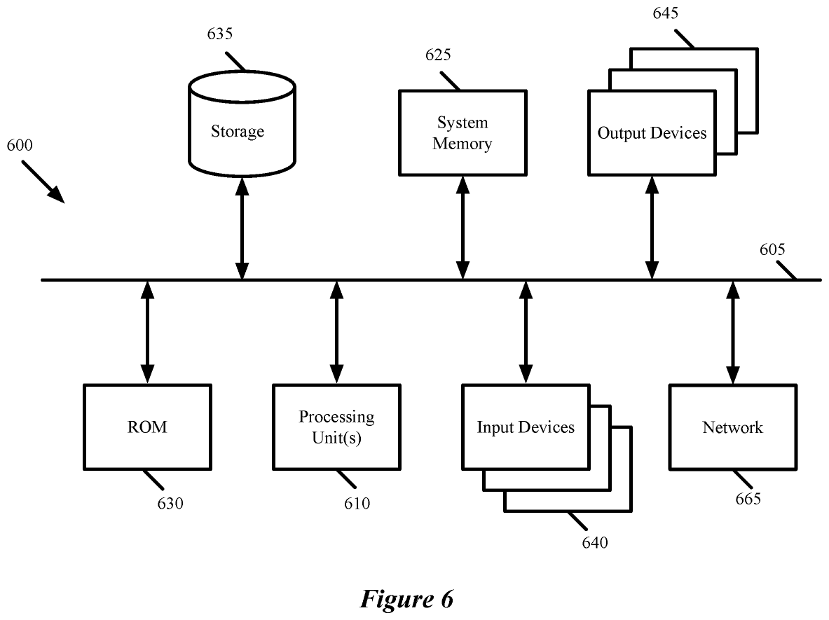

FIG. 6 conceptually illustrates a computer system 600 with which some embodiments of the invention are implemented. The computer system 600 can be used to implement any of the above-described hosts, controllers, gateway and edge forwarding elements. As such, it can be used to execute any of the above-described processes. This computer system 600 includes various types of non-transitory machine-readable media and interfaces for various other types of machine-readable media. Computer system 600 includes a bus 605, processing unit(s) 610, a system memory 625, a read-only memory 630, a permanent storage device 635, input devices 640, and output devices 645.

The bus 605 collectively represents all system, peripheral, and chipset buses that communicatively connect the numerous internal devices of the computer system 600. For instance, the bus 605 communicatively connects the processing unit(s) 610 with the read-only memory 630, the system memory 625, and the permanent storage device 635.

From these various memory units, the processing unit(s) 610 retrieve instructions to execute and data to process in order to execute the processes of the invention. The processing unit(s) may be a single processor or a multi-core processor in different embodiments. The read-only-memory (ROM) 630 stores static data and instructions that are needed by the processing unit(s) 610 and other modules of the computer system. The permanent storage device 635, on the other hand, is a read-and-write memory device. This device is a non-volatile memory unit that stores instructions and data even when the computer system 600 is off. Some embodiments of the invention use a mass-storage device (such as a magnetic or optical disk and its corresponding disk drive) as the permanent storage device 635.

Other embodiments use a removable storage device (such as a floppy disk, flash drive, etc.) as the permanent storage device 635. Like the permanent storage device 635, the system memory 625 is a read-and-write memory device. However, unlike storage device 635, the system memory 625 is a volatile read-and-write memory, such as random access memory. The system memory 625 stores some of the instructions and data that the processor needs at runtime. In some embodiments, the invention's processes are stored in the system memory 625, the permanent storage device 635, and/or the read-only memory 630. From these various memory units, the processing unit(s) 610 retrieve instructions to execute and data to process in order to execute the processes of some embodiments.

The bus 605 also connects to the input and output devices 640 and 645. The input devices 640 enable the user to communicate information and select commands to the computer system 600. The input devices 640 include alphanumeric keyboards and pointing devices (also called “cursor control devices”). The output devices 645 display images generated by the computer system 600. The output devices 645 include printers and display devices, such as cathode ray tubes (CRT) or liquid crystal displays (LCD). Some embodiments include devices such as touchscreens that function as both input and output devices 640 and 645.

Finally, as shown in FIG. 6, bus 605 also couples computer system 600 to a network 665 through a network adapter (not shown). In this manner, the computer 600 can be a part of a network of computers (such as a local area network (“LAN”), a wide area network (“WAN”), or an Intranet), or a network of networks (such as the Internet). Any or all components of computer system 600 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessors or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. For instance, several of the above-described embodiments deploy gateways in public cloud datacenters. However, in other embodiments, the gateways are deployed in a third-party's private cloud datacenters (e.g., datacenters that the third-party uses to deploy cloud gateways for different entities in order to deploy virtual networks for these entities). Thus, one of ordinary skill in the art would understand that the invention is not to be limited by the foregoing illustrative details, but rather is to be defined by the appended claims.

1. A method of selecting a backup overlay network route when rerouting data packets to avoid delays on a primary overlay network route, the method comprising:
for each of a plurality of overlay network routes, measuring delays of data packet transmissions on the overlay network route;
correlating changes in the delays of data packet transmissions sent through different overlay network routes of the plurality of overlay network routes;
selecting the backup overlay network route based on the backup overlay network route having a low correlation or no correlation of changes of delays with the primary overlay route.

2. The method of claim 1, wherein a plurality of physical network routes underlie the plurality of overlay network routes, and correlating changes in the delays of data packet transmissions sent through different overlay network routes of the plurality of overlay network routes comprises identifying overlay network routes for which the underlying physical network routes share infrastructure.

3. The method of claim 2, wherein the shared infrastructure comprises links in the physical network route.

4. The method of claim 1, wherein the correlating changes in the delays of data packet transmissions sent through different overlay network routes of the plurality of overlay network routes comprises identifying an increase in the round trip time along each of at least two routes within a threshold amount of time.

5. The method of claim 4, wherein the identified increase in the round trip time along each of the routes is more than a threshold increase.

6. The method of claim 1, wherein the correlating changes in the delays of data packet transmissions sent through different overlay network routes of the plurality of overlay network routes comprises identifying a decrease in the round trip time along each of at least two routes within a threshold amount of time.

7. The method of claim 6, wherein the decrease in the round trip time along each of the routes is more than a threshold decrease.

8. The method of claim 1, wherein measuring the delays comprises receiving, from an agent on at least one of a gateway of the overlay network and an endpoint of the overlay network, round trip time data for each overlay route.

9. The method of claim 1, wherein measuring the delays comprises receiving, from an agent on at least one of a gateways of the overlay network and an endpoint of the overlay network, latency time data for each overlay route.

10. The method of claim 1, wherein measuring the delays comprises receiving, from an agent on at least one of a gateway of the overlay network and an endpoint of the overlay network, packet error data for each overlay route.

11. The method of claim 1, wherein measuring the delays comprises receiving, from an agent on at least one of a gateway of the overlay network and an endpoint of the overlay network, network interruption data for each overlay route.

12. The method of claim 1, wherein a low correlation comprises a low correlation relative to correlations of other possible backup overlay network routes.

13. A non-transitory machine readable medium storing a program for selecting a backup overlay network route when rerouting data packets to avoid delays on a primary overlay network route, the program comprising sets of instructions for:
for each of a plurality of overlay network routes, measuring delays of data packet transmissions on the overlay network route;
correlating changes in the delays of data packet transmissions sent through different overlay network routes of the plurality of overlay network routes;
selecting the backup overlay network route based on the backup overlay network route having a low correlation or no correlation of changes of delays with the primary overlay route.

14. The non-transitory machine readable medium of claim 14, wherein a plurality of physical network routes underlie the plurality of overlay network routes, and correlating changes in the delays of data packet transmissions sent through different overlay network routes of the plurality of overlay network routes comprises identifying overlay network routes for which the underlying physical network routes share infrastructure.

15. The non-transitory machine readable medium of claim 14, wherein the shared infrastructure comprises links in the physical network route.

16. The non-transitory machine readable medium of claim 13, wherein the correlating changes in the delays of data packet transmissions sent through different overlay network routes of the plurality of overlay network routes comprises identifying an increase in the round trip time along each of at least two routes within a threshold amount of time.

17. The non-transitory machine readable medium of claim 16, wherein the identified increase in the round trip time along each of the routes is more than a threshold increase.

18. The non-transitory machine readable medium of claim 13, wherein the correlating changes in the delays of data packet transmissions sent through different overlay network routes of the plurality of overlay network routes comprises identifying a decrease in the round trip time along each of at least two routes within a threshold amount of time.

19. The non-transitory machine readable medium of claim 18, wherein the decrease in the round trip time along each of the routes is more than a threshold decrease.

20. The non-transitory machine readable medium of claim 13, wherein measuring the delays comprises receiving, from an agent on at least one of a gateway of the overlay network and an endpoint of the overlay network, round trip time data for each overlay route.
